(19) United States
(12) Patent Application Publication
(10) Pub. No.: US 2013/0343773 A1
(43) Pub. Date: Dec. 26, 2013

(54) METHOD AN APPARATUS FOR SELECTIVELY LOADING A CLEANING WEB IN A FUSER UNIT BASED ON MEDIA ATTRIBUTES

(71) Applicants: Melissa Ann MONAHAN, Rochester, NY (US); Erwin RUIZ, Rochester, NY (US); Steven RUSSEL, Bloomfield, NY (US); Jeffrey Nyyssonen SWING, Rochester, NY (US); Christopher Alan JENSEN, Rochester, NY (US)

(72) Inventors: Melissa Ann MONAHAN, Rochester, NY (US); Erwin RUIZ, Rochester, NY (US); Steven RUSSEL, Bloomfield, NY (US); Jeffrey Nyyssonen SWING, Rochester, NY (US); Christopher Alan JENSEN, Rochester, NY (US)

(73) Assignee: XEROX CORPORATION, Norwalk, CT (US)

(21) Appl. No.: 13/529,298

(22) Filed: Jun. 21, 2012

(51) Int. Cl. G03G 15/20; G03G 15/00

(52) U.S. Cl. 399/45; 399/67; 399/327

(57) ABSTRACT

An approach is provided for selectively loading a cleaning web useful in printing based on various media attributes of a media that is to be processed by a fuser unit. The approach involves determining one or more media attributes associated with a media to be processed by a fuser unit, the fuser unit comprising one or more heat rolls. The approach also involves determining at least one of the one or more media attributes meets a predetermined criteria. The approach further involves causing, at least in part, a cleaning web to contact at least one of the one or more heat rolls based, at least in part, on the determination that one or more media attributes meets the predetermined criteria.

### FIELD OF DISCLOSURE

The disclosure relates to a method and apparatus for selectively loading a cleaning web in a fuser unit based on media attributes.

### BACKGROUND

Conventional fuser units require cleaning and often use a cleaning web made of a fabric or polymer, for example, that can be costly. In conventional fuser units, the cleaning web is used to clean various portions of the fuser unit. For example, the cleaning web in a conventional fuser unit contacts one or more portions of the fuser unit such as one or more heat rolls to clean off toner and various contaminants. In conventional fuser units, the cleaning web is always loaded such that the cleaning web is always in contact with the one or more heat rolls. As such, the cleaning web is always used regardless of whether a particular print job is considered to be a clean job or a dirty job.

Clean jobs, for example, may be print jobs that do not cause, or cause very little, toner or other contaminate offset to the heat rolls from a media upon which an image is applied. Clean jobs, accordingly, may not require constant use of the cleaning web to maintain image quality. On the other hand, dirty jobs may be print jobs that cause significant toner or other contaminant offset to the heat rolls from a media upon which an image is applied. Dirty jobs, accordingly, may require use of the cleaning web to maintain image quality and avoiding image defects caused by toner offset and/or other contaminants.

In some conventional fuser units, the cleaning web is supplied roll-to-roll from a cleaning web supply roller to a cleaning web receiving roller. The cleaning web is conventionally supplied at a speed at or near a speed at which the one or more heat rolls rotate to reduce any friction between the cleaning web and the heat rolls. After use in a conventional fuser unit, regardless of whether the print job is a clean job or a dirty job, the cleaning web must be replaced because the cleaning web supply roller is depleted.

Some fuser units restrict the supply of cleaning web from the cleaning web supply roller to reduce cleaning web usage when it is determined that use of the cleaning web is not necessary to avoid depletion of any cleaning web supply. The restriction of supply may be, for example, by way of not feeding the cleaning web from the cleaning web supply roller to the cleaning web receiving roller such that the cleaning web is stationary, or reducing a speed at which the cleaning web is supplied from the cleaning web supply roller to the cleaning web receiving roller. But, because the cleaning web is always in contact with the one or more heat rolls, the cleaning web can become worn which may cause the cleaning web to break because the heat rolls are rotating, as discussed above.

The rotation of the heat rolls causes a degree of friction between the cleaning web and a surface of the heat roll that causes the cleaning web to wear. If the cleaning web were to break, then a printing process might have to be stopped to re-feed the cleaning web from the cleaning web supply roller to the cleaning web receiving roller. Additionally, even if the cleaning web does not break, some cleaning web is still used when the speed at which the cleaning web is supplied is reduced.

### SUMMARY

Therefore, there is a need for an approach to selectively load a cleaning web in a fuser unit based on various media attributes of a media that is to be processed by a fuser unit to reduce overall cleaning web usage.

According to one embodiment, a method useful in printing for selectively loading a cleaning web in a fuser unit comprises determining one or more media attributes associated with a media to be processed by a fuser unit, the fuser unit comprising one or more heat rolls. The method also comprises determining at least one of the one or more media attributes meets a predetermined criteria. The method further comprises causing, at least in part, a cleaning web to contact at least one of the one or more heat rolls based, at least in part, on the determination that one or more media attributes meets the predetermined criteria.

According to another embodiment, an apparatus useful in printing configured to selectively load a cleaning web in a fuser unit comprises at least one processor, and at least one memory including computer program code for one or more programs, the at least one memory and the computer program code configured to, with the at least one processor, cause the apparatus to determine one or more media attributes associated with a media to be processed by a fuser unit, the fuser unit comprising one or more heat rolls. The apparatus is also caused to determine at least one of the one or more media attributes meets a predetermined criteria. The apparatus is further caused to cause, at least in part, a cleaning web to contact at least one of the one or more heat rolls based, at least in part, on the determination that one or more media attributes meets the predetermined criteria.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments are illustrated by way of example, and not by way of limitation, in the figures of the accompanying drawings:

FIG. 1 is a diagram of a system capable of selectively loading a cleaning web in a fuser unit based on various media attributes, according to one embodiment;

FIG. 2 is a flowchart of a process for selectively loading a cleaning web in a fuser unit based on various media attributes, according to one embodiment; and

FIG. 3 is a diagram of a chip set that can be used to implement an embodiment.

### DETAILED DESCRIPTION

Examples of a method and apparatus for selectively loading a cleaning web in a fuser unit based on various media attributes are disclosed. In the following description, for the purposes of explanation, numerous specific details are set forth in order to provide a thorough understanding of the embodiments of the invention. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

As used herein, the term “fuser unit,” and any derivation thereof, shall refer to any apparatus having the effect of applying predetermined amounts of heat and/or pressure to a print sheet or media for any purpose. Typically, in xerographic printing, the fuser unit serves to partially melt powdered toner onto the print sheet, thereby yielding a substantially permanent image. In other applications, applied heat and/or pressure can be used for other specific purposes, such as to level and/or at least partially dry an ink jet image.

As used herein, the term “media,” and any derivation thereof, refers to a print sheet or substrate upon which an image may be applied, or has been applied, by way of a printing process.

As used herein, the term “media attribute,” and any derivation thereof, refers to any descriptive property of a media to be processed by a fuser unit, or any job attribute such as, but not limited to, a material type of the media, a roughness of the media, an amount of toner applied to the media, an amount of coating applied to the media, a type of toner applied to the media, a type of coating applied to the media, a type of image applied to the media, etc., or any combination thereof.

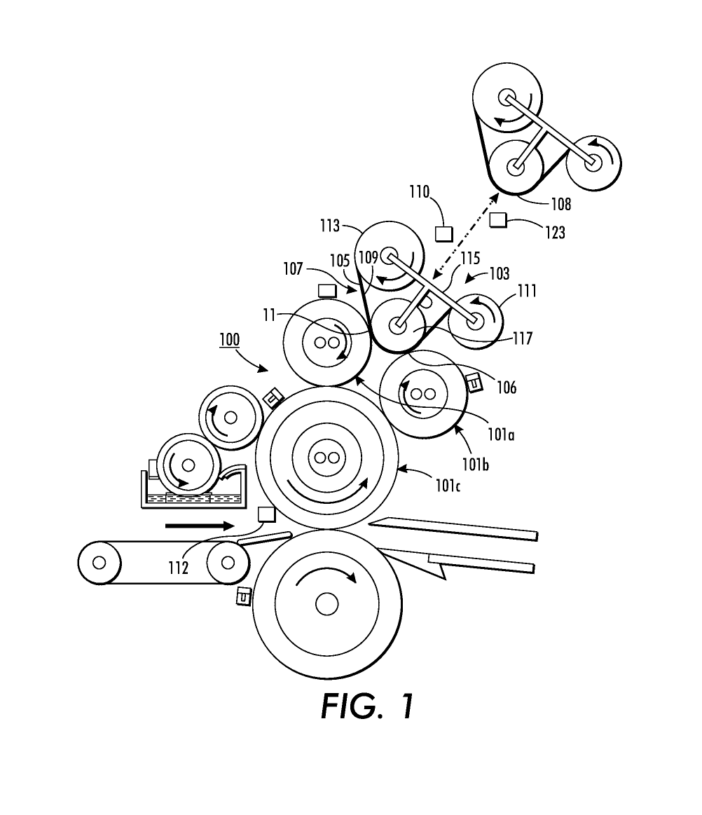

FIG. 1 is a diagram of a system capable of selectively loading a cleaning web in a fuser unit based on various media attributes, according to one embodiment.

Conventional fuser units require cleaning and often use a cleaning web made of a fabric or polymer, for example, that can be costly. In conventional fuser units, the cleaning web is used to clean various portions of the fuser unit regardless of whether a particular print job is considered to be a clean job or a dirty job. After use in a conventional fuser unit, regardless of whether the print job is a clean job or a dirty job, the cleaning web must be replaced because a cleaning web supply is depleted. Continually replacing the cleaning web can be an expensive procedure. Accordingly, there is a need to reduce consumption of the cleaning web.

Some fuser units, as discussed above, restrict the supply of cleaning web from the cleaning web supply roller to reduce cleaning web consumption. But, such tactics often cause the cleaning web to become worn or even break because, as discussed above. If the cleaning web breaks, then a printing process might have to be stopped to re-feed the cleaning web in the fuser unit, thereby reducing printed product manufacturing efficiency.

To address these problems, a fuser unit 100 of FIG. 1 introduces the capability to selectively load a cleaning web in the fuser unit 100 based on various media attributes. The fuser unit 100 is a fuser unit that requires cleaning following and/or during various printing processes. For example, the fuser unit 100 has various portions such as heat rolls 101a-101c (collectively referred to as heat roll(s) 101) that are cleaned by a cleaning unit 103. While illustrated as only having heat rolls 101a-101c, the fuser unit 100 may have any number of rollers or portions that require cleaning, and an infinite number of heat rolls 101 that may or may not each require cleaning For discussion purposes, the cleaning unit 103 will be referred to as cleaning heat rolls 101 as illustrated, but the cleaning applications of the cleaning unit 103 should not be so limited. For example, heat rolls 101a and 101b may be external heat rolls configured to raise a temperature of a main fuser roll 101c which may itself be a heat roll. Or the fuser unit 100 may have only the main fuser roll 101c, which may itself be a heat roll. Or the fuser unit 100 may have only heat rolls 101 comprising one external heat roll that requires cleaning and the main fuser roll 101c, for example.

The cleaning unit 103 is configured to clean the heat rolls 101, for example, using a cleaning web 105. With regard to the example heat rolls 101a-101c, discussed above, the cleaning unit 103 may be configured to clean one or more of the heat rolls 101a-101c. For example, depending on an arrangement of features of the fuser unit 100, the cleaning unit 103 may clean one or more of the external heat rolls 101a and 101b, only the main fuser roll 101c, or any combination thereof such as all of the heat rolls 101 or any pair of the heat rolls 101, for example.

The cleaning web 105 has a first surface 107 and a second surface 109. It should be noted that the definition of the first surface and second surface may be interchangeable. For example, the first surface 107 could be considered to be a second surface and the second surface 109 could be considered to be a first surface. For simplicity, however, first surface 107 can be considered to correspond to a surface of the cleaning web 105 that is used to clean a portion of the fuser unit 100 such as heat rolls 101 during a cleaning process.

As discussed above, the cleaning web 105 does not necessarily need to always be in contact with at least one of the heat rolls 101. For example, if a print job is deemed to be a clean job, the cleaning web 105 may not need to be in contact with the heat rolls 101 because cleaning of the heat rolls 101 is not required to maintain image quality.

As discussed above, in a conventional fuser unit, once the first surface 107 is used to clean a portion of the fuser unit, the cleaning web 105 is discarded. However, the cleaning unit 103, or any portions thereof, illustrated in FIG. 1 is configured to be movable between at least an engaged position 106 in which the cleaning web 105 is caused to contact at least one of the heat rolls 101 and a disengaged position 108 in which the cleaning web 105 is completely disengaged from the heat rolls 101 so that the cleaning web 105 is not in contact with at least one of the heat rolls 101.

In one or more embodiments, a processor 110 may determine various media attributes related to a media that is to be processed by the fuser unit 100. For example, media attributes may include any descriptive property of a media to be processed by the fuser unit 100 such as, but not limited to, a material type of the media, a roughness of the media, an amount of toner applied to the media, an amount of coating applied to the media, a type of toner applied to the media, a type of coating applied to the media, a type of image applied to the media, etc., or any combination thereof.

The processor 110 may determine the media attributes by way of various sensors 112, for example, or by way of a print job information input interface associated with the fuser unit 100 in which particular information regarding the parameters of a print job may be input for processing. For example, any media attribute may be input such that the media attributes may be processed by the processor 110.

Based upon the determined media attributes, the processor 110 may determine a print job is a clean job or a dirty job. The criteria for assigning whether a print job is a clean job or a dirty job may be predetermined, for example, based on any number of factors such as, but not limited to, any observed or estimated effects that particular media attributes have on image quality. For instance, if it is observed that a particular toner quantity or type typically affects image quality if the heat rolls 101 are not cleaned by the cleaning web 105, or if a default setting is established for a particular toner quantity or type, such an observation or setting may result in a determination that the toner quantity or type results in a dirty job. But, if for a different toner type or quantity, such an observation or setting does not result in image quality defects, then a determination may be made that such a toner quantity or type results in a clean job.

In one or more embodiments, any combination of media attributes may contribute to a determination of whether a print job is a clean job or a dirty job. For example, if a media material with one coating type is considered a dirty job, the same media with a different coating type may be considered a clean job. As such, it could be said that the coating type causes the print job to be a dirty job. But, if the different coating type is placed on a different media material, the print job may be determined to be a clean print job. In other words, some combinations of media attributes may offset various causes of dirty job types, while other combinations may enhance the determination of dirty job types. Therefore, the processor 110, may consider any number and/or combination of determined media attributes to assess whether the print job is a clean job or a dirty job

In one or more embodiments, upon a determination that the determined media attributes cause a clean job or a dirty job, the processor 110 causes the cleaning web 105 to contact or to not contact the heat rolls 101. According to various embodiments, as a default, the cleaning web 105 may be in contact with at least one of the one or more heat rolls 101, or not be in contact with at least one of the one or more heat rolls 101.

For example, if the default is such that the cleaning web 105 is not in contact with the heat rolls 101, the cleaning web 105 is completely disengaged from the heat rolls 101 before any adjustment of the cleaning web 105 occurs based on any determined media attributes. The complete disengagement of the cleaning web 105 enables the cleaning web 105 to be preserved and not used as discussed above , when the cleaning web 105 is in the disengaged position 108, the cleaning web 105 may not be fed from the cleaning web supply roller 111, to the cleaning web receiving roller 113 so that it remains stationary to avoid use of the cleaning web 105. In the event that the processor 110 determines that the media attributes of a media to be processed by the fuser unit 100 result in a print job that is a clean job, the processor 110 will cause the cleaning web 105 to remain in the disengaged position 108 so that the cleaning web 105 does not contact the heat rolls 101.

In one or more embodiments, the disengaged position 108 may be fixed or variable. For example, in one embodiment, the cleaning web 105 may be moved from a fixed disengaged position 108 to an engaged position 106 upon a determination that a print job is dirty. Or, in another embodiment, the disengaged position 108 may be any position in a range of motion of the cleaning web 105 toward and away from the heat rolls 101 so long as the cleaning web 105 does not contact the heat rolls 101. This may be helpful if the range of motion is long in a particular configuration of a fuser unit 100. It also may be helpful to anticipate a change in print job types from clean to dirty based on various media attributes for upcoming print jobs by moving the cleaning web 105 to a position that is as close as possible to the heat rolls 101 without contacting the heat rolls 101.

According to various embodiments, a range of motion of any of the components of the cleaning unit 103 and/or the cleaning web 105 may be on the order of a few fractions of an inch to multiple feet. For instance, complete disengagement of the cleaning web 105 from the heat rolls 101 may only need movement of the cleaning web 105 to be a few fractions of an inch such that the cleaning web 105 does not contact the heat rolls 101. However, depending upon a particular configuration of the fuser unit 100, to ensure complete disengagement of the cleaning web 105 from the heat rolls 101, the cleaning web 105 may be moved from the engaged position 106 to the disengaged position 108 by traveling in a range of motion of up to a few feet. Additionally, the range of motion of any of the components of the cleaning unit 103 and/or the cleaning web 105 may be in any direction from the engaged position 106 to the disengaged position 108. For example, as illustrated in FIG. 1, the cleaning web 105 may be caused to move at an angle of any degree away from the heat rolls 101 so that the cleaning web 105 does not contact the heat rolls 101 when the cleaning web 105 is in the disengaged position 108. However, the cleaning web 105 may be caused, for example, to move horizontally such that the cleaning web 105 still contacts one of the heat rolls 101, but not the other. Alternatively, the cleaning web 105 may be caused, for example, to move vertically such that the cleaning web 105 still contacts one of the heat rolls 101, but not the other. Such range of motion options may be selected on demand if the fuser unit 100 is so configured to accommodate such ranges of motion, or the fuser unit 100 may be configured to accommodate only one direction of range of motion such as a predetermined angle from the engaged position 106, or vertically or horizontally from the engaged position 106.

If the processor 110 determines that the print job type is a dirty job based on the determined media attributes, the processor 110 causes the cleaning web 105 to contact at least one of the one or more heat rolls 101. In various embodiments, the fuser unit 100 may be configured to accommodate any number of cleaning units 103 to clean any number of heat rolls 101 individually or in combination.

In an alternative embodiment, if the default position of the cleaning web 105 is such that the cleaning web 105 is in contact with the heat rolls 101, the cleaning web 105 is in the engaged position 106. If the processor 110 determines that the print job type is a dirty job based on the determined media attributes, the processor 110 causes the cleaning web 105 to remain in the engaged position 106 and contact at least one of the one or more heat rolls 101.

But, in the event that the processor 110 determines that the media attributes of a media to be processed by the fuser unit 100 results in a print job that is a clean job, the processor 110 will cause the cleaning web 105 to be moved to the disengaged position 108 so that the cleaning web 105 does not contact the heat rolls 101.

As shown in FIG. 1, the fuser unit 100 comprises heat rolls 101, cleaning unit 103, cleaning web 105, cleaning web supply roller 111, cleaning web receiving roller 113, cleaning apparatus support 115, and cleaning web application roller 117.

According to various embodiments, the cleaning unit 103 may take many forms. For example, the cleaning unit 103 may separately comprise the cleaning web supply roller 111, the cleaning web receiving roller 113 and cleaning web application roller 117. Alternatively, the cleaning unit 103 may be a cartridge, such as that illustrated in FIG. 1, comprising the cleaning web supply roller 111, cleaning web receiving roller 113, cleaning web application roller 117 and optionally the cleaning apparatus support 115.

The cleaning web supply roller 111 is a roller configured to accommodate a spool of cleaning web 105. The cleaning web 105 may be unwound from the cleaning web supply roller 111 either clockwise or counter-clockwise as it is fed to one or more cleaning regions such as any cleaning nip 119 formed between cleaning web application roller 117 and heat rolls 101, for example. Following a cleaning process that uses the cleaning web 105, the cleaning web 105 is received by the cleaning web receiving roller 113. In FIG. 1, the cleaning web receiving roller 113 is a roller that is configured to wind the cleaning web 105 after the first surface 107 of the cleaning web 105 is used to clean heat rolls 101. The cleaning web receiving roller 113, may wind the cleaning web 105 either clockwise or counter-clockwise.

According to various embodiments, the processor 110 may communicate with a cleaning web position control unit 123 to cause the cleaning web 105 to be moved between the engaged position 106 and the disengaged position 108. The cleaning web position control unit 123 may be any of, for example, a camming mechanism or a solenoid loading mechanism, among other types of motors or means for inducing a movement of the cleaning web between the engaged position 106 to the disengaged position 108.

In one embodiment, the cleaning web position control unit 123 may be configured to cause the cleaning web application roller 117 to be moved such that the cleaning web is caused to move between the engaged position 106 and the disengaged position 108. In another embodiment, the cleaning web position control unit 123 may be configured to cause the entire cleaning unit 103 to be moved such that the cleaning web 105 is moved between the engaged position 106 and the disengaged position 108.

According to various embodiments, if the cleaning unit 103 is a cartridge, the cleaning web position control unit 123 may be configured to interact with any feature of the cleaning unit 103 to cause the movement of the cartridge-type cleaning unit 103. For example, the cleaning web position control unit 123 may interact directly with the cleaning apparatus support 115 to induce the movement of the cleaning unit 103 to cause the cleaning web 105 to the moved between the engaged position 106 and the disengaged position 108. Alternatively, or in addition to, the entire cartridge-type cleaning unit 103 being moved by the cleaning web position control unit 123, cartridge-type cleaning unit 103 may be configured to enable the cleaning web application roller 117 to be moved by the cleaning web position control unit 123 to cause the cleaning web 105 to be moved between the engaged position 106 and the disengaged position 108.

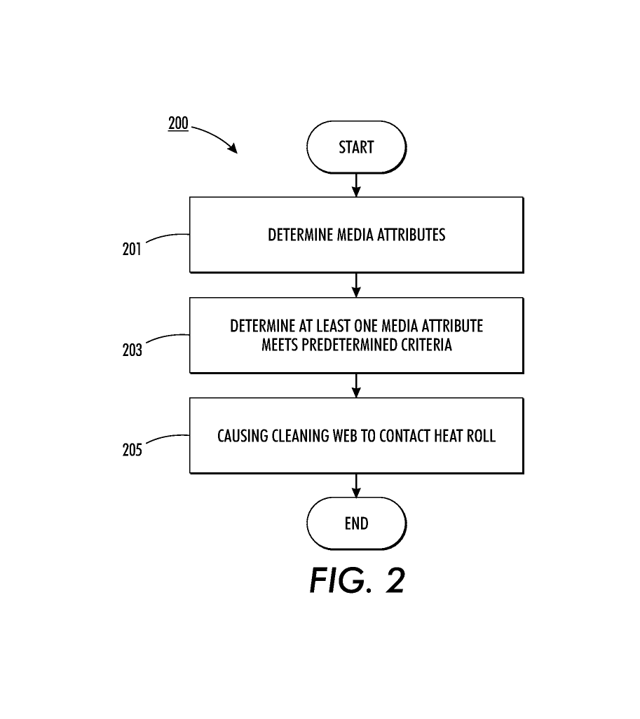

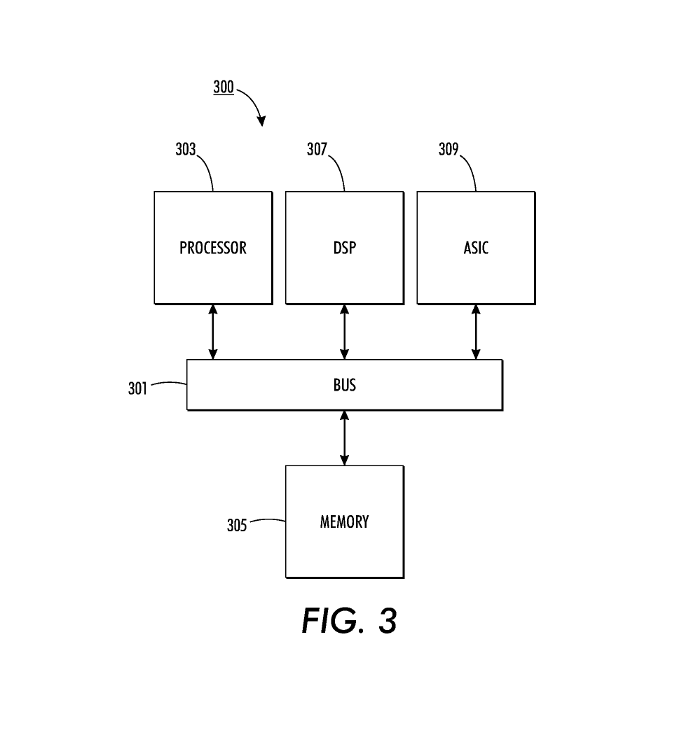

FIG. 2 is a flowchart of a process for selectively loading a cleaning web in a fuser unit based on various media attributes, according to one embodiment. In one embodiment, the processor 110 may perform the process 200 or the process may be implemented by a chip set 300 including a processor and a memory as shown in FIG. 3. In step 201, one or more media attributes associated with a media to be processed by the fuser unit 100 discussed above are determined. The fuser unit 100, as discussed above, comprises one or more heat rolls 101. The process continues to step 203 in which at least one of the one or more media attributes is determined to meet a predetermined criteria. The predetermined criteria, as discussed above, may be any observed, estimated, or present indication that a particular media attribute, or combination of media attributes may be considered to cause a print job that is a dirty job. Then, in step 305, the cleaning web 105 is caused to contact at least one of the one or more heat rolls 101 based, at least in part, on the determination that one or more media attributes meets the predetermined criteria.

As discussed above, the cleaning web 105 may be caused to contact the at least one of the one or more heat rolls by causing, at least in part, at least one cleaning nip 119 to be formed between the cleaning web application roller 117 and the at least one of the one or more heat rolls 101 when the cleaning web 105 is caused to contact the at least one of the one or more heat rolls 101. The cleaning web 105, accordingly, is fed from the cleaning web supply roller 111 to the cleaning web receiving roller 113 through the at least one cleaning nip 119 such that the cleaning web 105 contacts the at least one of the one or more heat rolls 101.

Further, the cleaning web 105 may be caused to contact the at least one of the one or more heat rolls 101 by causing, at least in part, the cleaning web application roller 117 to be moved between at least the disengaged position 108 in which the cleaning web is completely disengaged from the at least one of the one or more heat rolls 101 and the engaged position 106 in which the cleaning web is in contact with the at least one of the one or more heat rolls 101 when the cleaning web 105 is caused to contact the at least one of the one or more heat rolls 101.

Alternatively, as discussed above, when the cleaning unit 103 is installed into the fuser unit 100 as a cartridge, the cartridge may be caused to move between at least the disengaged position 108 in which the cleaning web 105 is completely disengaged from the at least one of the one or more heat rolls 101 and the engaged position 106 in which the cleaning web 105 is in contact with the at least one of the one or more heat rolls 101 when the cleaning web 105 is caused to contact the at least one of the one or more heat rolls 101.

Or, in another embodiment, when the cleaning unit 103 is installed into the fuser unit 100 as a cartridge, the cleaning web application roller 117, alone, in addition to the entire cartridge being moved, may be caused to move between at least the disengaged position 108 in which the cleaning web 105 is completely disengaged from the at least one of the one or more heat rolls 101 and the engaged position 106 in which the cleaning web is in contact with the at least one of the one or more heat rolls 101 when the cleaning web 105 is caused to contact the at least one of the one or more heat rolls 101.

The processes described herein for selectively loading a cleaning web in a fuser unit based on various media attributes of a media that is to be processed by a fuser unit may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 3 illustrates a chip set or chip 300 upon which an embodiment may be implemented. Chip set 300 is programmed to selectively load a cleaning web in a fuser unit based on various media attributes of a media that is to be processed by a fuser unit as described herein may include, for example, bus 301, processor 303, memory 305, DSP 307 and ASIC 309 components.

The processor 303 and memory 305 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 300 can be implemented in a single chip. It is further contemplated that in certain embodiments the chip set or chip 300 can be implemented as a single “system on a chip.” It is further contemplated that in certain embodiments a separate ASIC would not be used, for example, and that all relevant functions as disclosed herein would be performed by a processor or processors. Chip set or chip 300, or a portion thereof, constitutes a means for performing one or more steps of selectively loading a cleaning web in a fuser unit based on various media attributes of a media that is to be processed by a fuser unit.

In one or more embodiments, the chip set or chip 300 includes a communication mechanism such as bus 301 for passing information among the components of the chip set 300. Processor 303 has connectivity to the bus 301 to execute instructions and process information stored in, for example, a memory 305. The processor 303 may include one or more processing cores with each core configured to perform independently. A multi-core processor enables multiprocessing within a single physical package. Examples of a multi-core processor include two, four, eight, or greater numbers of processing cores. Alternatively or in addition, the processor 303 may include one or more microprocessors configured in tandem via the bus 301 to enable independent execution of instructions, pipelining, and multithreading. The processor 303 may also be accompanied with one or more specialized components to perform certain processing functions and tasks such as one or more digital signal processors (DSP) 307, or one or more application-specific integrated circuits (ASIC) 309. A DSP 307 typically is configured to process real-world signals (e.g., sound) in real time independently of the processor 303. Similarly, an ASIC 309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one or more embodiments, the processor (or multiple processors) 303 performs a set of operations on information as specified by computer program code related to selectively loading a cleaning web in a fuser unit based on various media attributes of a media that is to be processed by a fuser unit. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 301 and placing information on the bus 301. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 303, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 303 and accompanying components have connectivity to the memory 305 via the bus 301. The memory 305 may include one or more of dynamic memory (e.g., RAM, magnetic disk, writable optical disk, etc.) and static memory (e.g., ROM, CD-ROM, etc.) for storing executable instructions that when executed perform the inventive steps described herein to selectively load a cleaning web in a fuser unit based on various media attributes of a media that is to be processed by a fuser unit. The memory 305 also stores the data associated with or generated by the execution of the inventive steps.

In one or more embodiments, the memory 305, such as a random access memory (RAM) or any other dynamic storage device, stores information including processor instructions for selectively loading a cleaning web in a fuser unit based on various media attributes of a media that is to be processed by a fuser unit. Dynamic memory allows information stored therein to be changed by fuser unit 100. RAM allows a unit of information stored at a location called a memory address to be stored and retrieved independently of information at neighboring addresses. The memory 305 is also used by the processor 303 to store temporary values during execution of processor instructions. The memory 305 may also be a read only memory (ROM) or any other static storage device coupled to the bus 301 for storing static information, including instructions, that is not changed by the fuser unit 100. Some memory is composed of volatile storage that loses the information stored thereon when power is lost. The memory 305 may also be a non-volatile (persistent) storage device, such as a magnetic disk, optical disk or flash card, for storing information, including instructions, that persists even when the fuser unit 100 is turned off or otherwise loses power.

The term “computer-readable medium” as used herein refers to any medium that participates in providing information to processor 303, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the invention is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method useful in printing for selectively loading a cleaning web in a fuser unit, the method comprising:
determining one or more media attributes associated with a media to be processed by a fuser unit, the fuser unit comprising one or more heat rolls;
determining at least one of the one or more media attributes meets a predetermined criteria; and
causing, at least in part, a cleaning web to contact at least one of the one or more heat rolls based, at least in part, on the determination that one or more media attributes meets the predetermined criteria.

2. The method of claim 1, wherein a cleaning unit comprises a cleaning web supply roller, a cleaning web receiving roller, and a cleaning web application roller, the method further comprising:
causing, at least in part, at least one cleaning nip to be formed between the cleaning web application roller and the at least one of the one or more heat rolls when the cleaning web is caused to contact the at least one of the one or more heat rolls; and
causing, at least in part, the cleaning web to be fed from the cleaning web supply roller to the cleaning web receiving roller through the at least one cleaning nip such that the cleaning web contacts the at least one of the one or more heat rolls.

3. The method of claim 1, wherein a cleaning unit comprises a cleaning web supply roller, a cleaning web receiving roller, and a cleaning web application roller, the method further comprising:
causing, at least in part, the cleaning web application roller to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

4. The method of claim 1, wherein a cleaning unit comprises a cleaning web supply roller, a cleaning web receiving roller, and a cleaning web application roller, and the cleaning web supply roller, the cleaning web receiving roller, and the cleaning web application roller are configured to be installed into the fuser unit together as a cartridge, the method further comprising:
causing, at least in part, the cleaning web application roller to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

5. The method of claim 1, wherein a cleaning unit comprises a cleaning web supply roller, a cleaning web receiving roller, and a cleaning web application roller, and the cleaning web supply roller, the cleaning web receiving roller, and the cleaning web application roller are configured to be installed into the fuser unit together as a cartridge, the method further comprising:
causing, at least in part, the cartridge to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

6. A method of claim 1, wherein the cleaning web is caused to contact the at least one of the one or more heat rolls at least by way of a camming mechanism.

7. A method of claim 1, wherein the cleaning web is caused to contact the at least one of the one or more heat rolls at least by way of a solenoid mechanism.

8. A method of claim 1, wherein the one or more media attributes comprises an amount of toner applied to the media by a printing process.

9. A method of claim 1, wherein the one or more media attributes comprises a media coating.

10. A method of claim 1, wherein the one or more media attributes comprises one or more of a media roughness and a media material.

11. A method of claim 1, wherein the one or more heat rolls comprises a main fuser roll configured to contact the media processed by the fuser unit.

12. A method of claim 1, wherein the one or more heat rolls comprises one or more external heat rolls configured to raise a temperature of a main fuser roll, the main fuser roll being configured to contact the media processed by the fuser unit.

13. An apparatus useful in printing configured to selectively load a cleaning web in a fuser unit, the apparatus comprising:
at least one processor; and
at least one memory including computer program code for one or more programs,
the at least one memory and the computer program code configured to, with the at least one processor, cause the apparatus to perform at least the following:
determine one or more media attributes associated with a media to be processed by a fuser unit, the fuser unit comprising one or more heat rolls;
determine at least one of the one or more media attributes meets a predetermined criteria; and
cause, at least in part, a cleaning web to contact at least one of the one or more heat rolls based, at least in part, on the determination that one or more media attributes meets the predetermined criteria.

14. An apparatus of claim 13, wherein a cleaning unit comprises a cleaning web supply roller, a cleaning web receiving roller, and a cleaning web application roller, and the apparatus is further caused to:
cause, at least in part, at least one cleaning nip to be formed between the cleaning web application roller and the at least one of the one or more heat rolls when the cleaning web is caused to contact the at least one of the one or more heat rolls; and
cause, at least in part, the cleaning web to be fed from the cleaning web supply roller to the cleaning web receiving roller through the at least one cleaning nip such that the cleaning web contacts the at least one of the one or more heat rolls.

15. An apparatus of claim 13, wherein a cleaning unit comprises a cleaning web supply roller, a cleaning web receiving roller, and a cleaning web application roller, and the apparatus is further caused to:
cause, at least in part, the cleaning web application roller to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

16. An apparatus of claim 13, wherein a cleaning unit comprises a cleaning web supply roller, a cleaning web receiving roller, and a cleaning web application roller, and the cleaning web supply roller, the cleaning web receiving roller, and the cleaning web application roller are configured to be installed into the fuser unit together as a cartridge, and the apparatus is further caused to:
cause, at least in part, the cleaning web application roller to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

17. An apparatus of claim 13, wherein a cleaning unit comprises a cleaning web supply roller, a cleaning web receiving roller, and a cleaning web application roller, and the cleaning web supply roller, the cleaning web receiving roller, and the cleaning web application roller are configured to be installed into the fuser unit together as a cartridge, and the apparatus is further caused to:
cause, at least in part, the cartridge to move between at least a disengaged position in which the cleaning web is completely disengaged from the at least one of the one or more heat rolls and an engaged position in which the cleaning web is in contact with the at least one of the one or more heat rolls when the cleaning web is caused to contact the at least one of the one or more heat rolls.

18. An apparatus of claim 13, wherein the cleaning web is caused to contact the at least one of the one or more heat rolls at least by way of a camming mechanism.

19. An apparatus of claim 13, wherein the cleaning web is caused to contact the at least one of the one or more heat rolls at least by way of a solenoid mechanism.

20. An apparatus of claim 13, wherein the one or more media attributes comprises an amount of toner applied to the media by a printing process.

21. An apparatus of claim 13, wherein the one or more media attributes comprises a media coating.

22. An apparatus of claim 13, wherein the one or more media attributes comprises one or more of a media roughness and a media material.
